(19) United States
(12) Patent Application Publication
(10) Pub. No.: US 2016/0274650 A1
(43) Pub. Date: Sep. 22, 2016

(54) INTERFACE SUPPLY CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JUN-YI DENG, Wuhan (CN); CHUN-SHENG CHEN, New Taipei (TW)

(21) Appl. No.: 14/692,344

(22) Filed: Apr. 21, 2015

(30) Foreign Application Priority Data
Mar. 18, 2015 (CN) 201510118523.0

(51) Int. Cl. G06F 1/32

(52) U.S. Cl. CPC G06F 1/3287; G06F 1/3253

(57) ABSTRACT

An interface supply circuit includes a power supply unit, a switch unit coupled to the power supply unit, and a control unit coupled to the switch unit. The control unit and the switch unit are configured to couple to an interface. The control unit is configured to output a first control signal in event that a corresponding device is inserted into the interface. The switch unit is configured activate upon receiving the first control signal. The power supply unit is configured to supply power to the interface after the switch unit is activated. The control unit is further configured to output a second control signal in event that no device is inserted into the interface. The switch unit is further configured to be switched off after receiving the second control signal. The power supply unit is configured to be disconnected from the interface in event the switch unit is switched off.

### FIELD

The subject matter herein generally relates to power supply circuits.

### BACKGROUND

Some interfaces are mounted in a motherboard. A power supply unit supplies power to the interfaces. A corresponding device is configured to be inserted into an interface. For example, a universal serial bus (USB) device can be inserted into a USB interface and a high definition multimedia interface (HDMI) device can be inserted into a HDMI interface. Power is continued to be supplied to the interface even though no corresponding device is inserted into the interface, thereby increasing usage of power and a high risk of short circuits at the interface.

### BRIEF DESCRIPTION OF THE DRAWINGS

Implementations of the present technology will now be described, by way of example only, with reference to the attached figures.

FIG. 1 is a block diagram of one embodiment of an interface supply circuit, an interface, and a device.

FIG. 2 is a circuit diagram of the interface supply circuit and the interface of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a power supply circuit used to supply power to an interface.

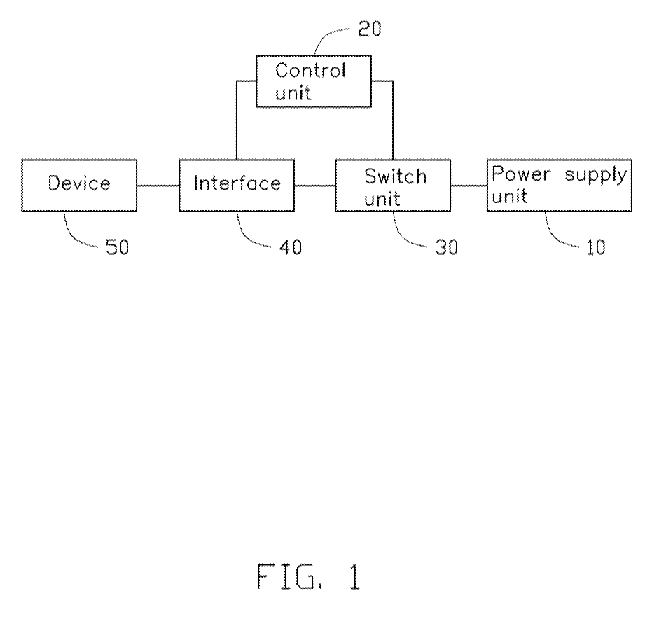

FIG. 1 illustrates an embodiment of an interface supply circuit. The interface supply circuit comprises a power supply unit 10, a control unit 20, and a switch unit 30. The power supply unit 10 is coupled to the switch unit 30. The switch unit 30 is coupled to the control unit 20. The control unit 20 and the switch unit 30 are configured to couple to an interface 40. The power supply unit 10 is configured to supply power to the interface 40 via the control unit 20. The interface 40 is configured to receive a device 50.

The interface 40 comprises a power supply pin VCC, a ground pin GND, and a signal pin DET.

The control unit 20 is configured to output a first control signal after receiving the device 50. The switch unit 30 is configured to be switched on after receiving the first control signal. The power supply unit 10 is configured to supply power to the interface 40 after the switch unit 30 is switched on.

The control unit 20 is also configured to output a second control signal after receiving the device 50 incorrectly. The switch unit 30 is configured to be switched off after receiving the second control signal. The power supply unit 10 is configured to be disconnected from the interface 40 after the switch unit 30 is switched off, thereby preventing short circuits when conductive materials drop into the interface 40.

The control unit 20 is further configured to output the second control signal after receiving no device 50, thereby the power supply unit 10 is disconnected from the interface 40, thus preventing short circuits when conductive materials drop into the interface 40.

In one embodiment, the first control signal is a low level (logic 0) signal and the second control signal is a high level (logic 1) signal.

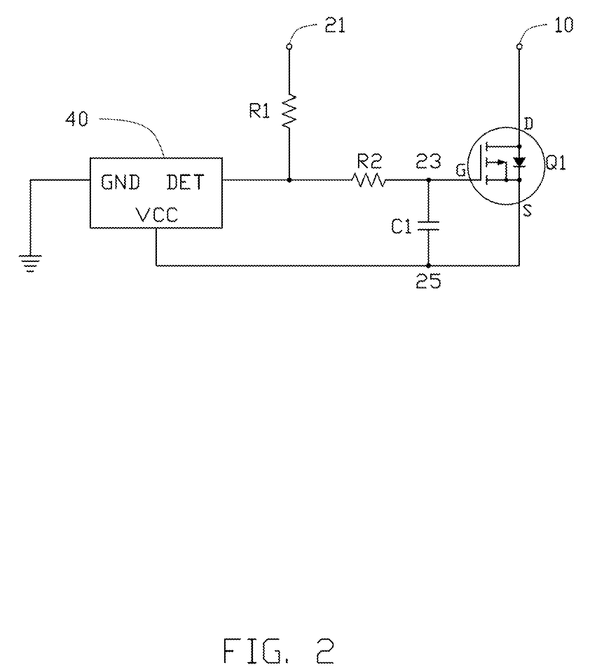

FIG. 2 illustrates the control unit 20 comprises a power supply 21 and a first resistor R1. The switch unit 30 comprises a first field effect transistor (FET) Q1, a second resistor R2, and a capacitor C1. The first FET Q1 comprises a control terminal G, a first connecting terminal S, and a second connecting terminal D.

The signal pin DET of the interface 40 is coupled to one end of the first resistor R1. The other end of the first resistor R1 is coupled to the power supply 21. The signal pin DET of the interface 40 is coupled to one end of the second resistor R2. The other end of the second resistor R2 is coupled to a first node 23. The first node 23 is coupled to one end of the capacitor C1. The other end of the capacitor C1 is coupled to a second node 25. The second node 25 is coupled to the first connecting terminal S of the first FET Q1. The second node 25 is coupled to the power supply pin VCC of the interface 40. The ground pin GND of the interface 40 is grounded. The first node 23 is coupled to the control terminal G of the first FET Q1. The second connecting terminal D of the first FET Q1 is coupled to the power supply unit 10.

In one embodiment, the first FET Q1 is an n-channel FET, the control terminal G of the first FET Q is a gate terminal, the first connecting terminal S of the first FET Q is a source terminal, and the second connecting terminal D of the first FET Q is a drain terminal.

A working principle of the interface supply circuit is as follows. When the device 50 is inserted into the interface 40, the control unit 20 outputs a first control signal. The switch unit 30 is switched on after receiving the first control signal. The power supply unit 10 supplies power to the interface 40. When the device 50 is inserted into the interface 40 incorrectly or no device 50 is inserted into the interface 40, the control unit 20 outputs a second control signal. After receiving the second control signal, the switch unit 30 is switched off. The power supply unit 10 is disconnected from the interface 40; the power supply unit 10 does not supply power to the interface 40, thereby preventing short circuits when conductive materials drop into the interface 40.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An interface supply circuit comprising:
a power supply unit;
a switch unit coupled to the power supply unit, and
a control unit coupled to the switch unit;
wherein the control unit and the switch unit are configured to couple to an interface;
wherein the control unit is further configured to output a first control signal in event that a corresponding device is inserted into the interface;
wherein the switch unit is further configured activate upon receiving the first control signal; and
wherein the power supply unit is configured to supply power to the interface in event the switch unit is activated.

2. The interface supply circuit of claim 1, wherein the switch unit comprises a field effect transistor (FET), the FET comprises a control terminal, a first connecting terminal, and a second connecting terminal, the control terminal of the FET is coupled to the control unit, the first connecting terminal of the FET is configured to couple to the interface, and the second connecting terminal of the FET is coupled to the power supply unit.

3. The interface supply circuit of claim 2, wherein the switch unit further comprises a first resistor, one end of the first resistor is coupled to the control unit, and the other end of the first resistor is coupled to the control terminal of the FET.

4. The interface supply circuit of claim 3, wherein the control unit further comprises a power supply and a second resistor, one end of the second resistor is coupled to the power supply, and the other end of the second resistor is configured to couple to the interface.

5. The interface supply circuit of claim 4, wherein the interface comprises a power supply pin and a signal pin, the second resistor is coupled between the signal pin of the interface and the power supply, and the first connecting terminal of the FET is coupled to the power supply pin of the interface.

6. The interface supply circuit of claim 2, wherein the switch unit further comprises a capacitor, one end of the capacitor is coupled to the control terminal of the FET, and the other end of the capacitor is coupled to the first connecting terminal of the FET.

7. The interface supply circuit of claim 2, wherein the FET is an n-channel FET.

8. The interface supply circuit of claim 7, wherein the control terminal of the FET is a gate terminal, the first connecting terminal of the FET is a source terminal, and the second connecting terminal of the FET is a drain terminal.

9. The interface supply circuit of claim 1, wherein the control unit is further configured to output a second control signal after no corresponding device is inserted into the interface, the switch unit is further configured to be switched off after receiving the second control signal and the power supply unit is configured to be disconnected from the interface after the switch unit is switched off.

10. The interface supply circuit of claim 9, wherein the second control is a high level signal.

11. An interface supply circuit comprising:
a switch unit couplable to an interface;
a power supply unit coupled to the switch unit; and
a control unit coupled to the switch unit and couplable to the interface;
wherein the control unit is configured to output a first control signal in event that corresponding device is inserted into the interface and output a second control signal after no corresponding device is inserted into the interface;
wherein the switch unit is configured activate upon receiving the first control signal and be switched off after receiving the second control signal; and
wherein the power supply unit is configured to supply power to the interface in event the switch unit is activated and be disconnected from the interface after the switch unit is switched off.

12. The interface supply circuit of claim 11, wherein the switch unit comprises a field effect transistor (FET), the FET comprises a control terminal, a first connecting terminal, and a second connecting terminal, the control terminal of the FET is coupled to the control unit, the first connecting terminal of the FET is configured to couple to the interface, and the second connecting terminal of the FET is coupled to the power supply unit.

13. The interface supply circuit of claim 12, wherein the switch unit further comprises a first resistor and a capacitor, one end of the first resistor is coupled to the control unit, the other end of the first resistor is coupled to the control terminal of the FET, one end of the capacitor is coupled to the control terminal of the FET, and the other end of the capacitor is coupled to the first connecting terminal of the FET.

14. The interface supply circuit of claim 13, wherein the control unit further comprises a power supply and a second resistor, one end of the second resistor is coupled to the power supply, and the other end of the second resistor is configured to couple to the interface.

15. The interface supply circuit of claim 14, wherein the interface comprises a power supply pin and a signal pin, the second resistor is coupled between the signal pin of the interface and the power supply, and the first connecting terminal of the FET is coupled to the power supply pin of the interface.

16. The interface supply circuit of claim 12, wherein the FET is an n-channel FET.

17. The interface supply circuit of claim 16, wherein the control terminal of the FET is a gate terminal, the first connecting terminal of the FET is a source terminal, and the second connecting terminal of the FET is a drain terminal.

18. The interface supply circuit of claim 11, wherein the second control is a high level signal.

19. The interface supply circuit of claim 18, wherein the first control is a low level signal.

20. The interface supply circuit of claim 11, wherein the control unit is further configured to output the second control signal after receiving the device incorrectly, the power supply unit is configured to be disconnected from the interface after the switch unit receives the second control signal.
